(19) United States
(12) Patent Application Publication
(10) Pub. No.: US 2015/0281761 A1
(43) Pub. Date: Oct. 1, 2015

(54) HDMI DEVICE CONTROL VIA IP

(71) Applicant: SONY CORPORATION, TOKYO (JP)

(72) Inventor: Armin Mank, Waiblingen (DE)

(73) Assignee: SONY CORPORATION, Tokyo (JP)

(21) Appl. No.: 14/429,214

(22) PCT Filed: Sep. 24, 2013
(86) PCT No.: PCT/EP2013/069830

§ 371 Date: Mar. 18, 2015

(30) Foreign Application Priority Data
Oct. 24, 2012 (EP) 12189658.3
Dec. 12, 2012 (EP) 12196708.7

(51) Int. Cl. H04N 21/422; H04N 21/4227; H04N 21/485; H04N 21/436; H04N 21/4363; H04W 4/00; H04N 21/41

(52) U.S. Cl. CPC H04N 21/4222; H04W 4/008; H04N 21/42224; H04N 21/42208; H04N 21/4227; H04N 21/42207; H04N 21/4126; H04N 21/43615; H04N 21/43635; H04N 21/485; H04W 84/12

(57) ABSTRACT

A method including: transmitting information about network devices of an HDMI, high definition multimedia interface, network by an HDMI network device; receiving the information by a remote control device; presenting the network devices of the HDMI network on a display of the control device as selectable by a user; presenting a set of control command softkeys on the display in response to a selection of a network device, the set being selected dependent on the type of network device; generating control command data on the basis of a selected control command softkey; transmitting the control command data to the HDMI network device; and providing a CEC command in response to the received control command data.

### BACKGROUND

1. Field of the Disclosure

The present disclosure relates to a method which could be used to remotely control HDMI devices via a mobile device, like a smartphone, tablet computer, the mobile device being connected with the HDMI network. The present disclosure also relates to a control device for remotely controlling network devices of an HDMI network, an HDMI device, a computer program and a non-transitory computer-readable recording medium.

2. Description of Related Art

HDMI (high definition multimedia interface) is a compact audio/video interface for transferring uncompressed digital audio/video data from an HDMI compliant device (“the source”) to a compatible digital audio device, computer monitor, video projector and digital television set. Such HDMI devices are connected with each other via the HDMI interface forming an HDMI network. The control of the HDMI devices is allowed by CEC (consumer electronics control). CEC also allows the user to operate multiple HDMI devices with one remote control handset. For example, the handset communicating with the TV set could also control a blue ray player, a set top box, a DVD player, etc. coupled with the TV set. In particular, the TV set receives a respective control command from the IR remote controller of the TV set and transmits the respective command via CEC to the respective HDMI device.

There is an increasing demand to control HDMI devices of an HDMI network by using mobile devices, like smartphones, tablets, etc. In particular, there is a demand to allow control of all HDMI devices of an HDMI network by such a mobile device.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly or impliedly admitted as prior art against the present invention.

### SUMMARY

It is an object to provide a method which allows to control preferably every device of an HDMI network. It is a further object to provide a control device for remotely controlling network devices of an HDMI network. It is a still further object to provide an HDMI device enabling the control of each HDMI device of the network with another device not being member of the HDMI network.

According to an aspect there is provided a method comprising transmitting information about network devices of an HDMI network by an HDMI network device, receiving this information by a remote control device, presenting said network devices of said HDMI network on a display of said control device as selectable by a user, presenting a set of control command softkeys on the display in response to a selection of a network device, the set being selected dependent on the type of network device, generating control command data on the basis of a selected control command softkey, transmitting said control command data to said HDMI network device, and providing a CEC command in response to the received control command data.

According to a further aspect there is provided a method comprising:
providing information about network devices of an HDMI network,
transmitting said information to a remote control device,
receiving control command data from said control device, and
providing a CEC command in response to the received control command data.

According to a further aspect there is provided a control device for remotely controlling network devices of an HDMI network, comprising:
a display,
a communication interface adapted to communicate with an HDMI network device,
a network device selection unit adapted to receive a network device selection command by a user,
a control command selection unit adapted to display at least one control command softkey associated with said selective network device on the display, and
a control command data generation unit adapted to generate control command data for transmitting to said HDMI network device in response to the selection of a control command softkey.

According to a further aspect there is provided an HDMI device comprising
a communication interface adapted to communicate with a control device,
a HDMI network information generation unit adapted to generate information about the network devices of the HDMI network, and
a command receiving unit adapted to receive data from the control device via the communication interface and to provide a CEC command on the basis of the received data.

Preferred embodiments are defined in the dependent claims. It shall be understood that the claimed device, the claimed methods, the claimed computer program and the claimed computer-readable recording medium have similar and/or identical preferred embodiments as the claimed method and as defined in the dependent claims.

One of the aspects of the present disclosure is to provide means allowing that control devices, like mobile devices, tablets etc, can be enabled to control HDMI devices of an HDMI network. One of the HDMI devices of the network is adapted to receive/send control data from/to the control device via a communication path which is not an HDMI connection, and to forward and translate commands from the control device into CEC commands and vice versa. As along as one device in the HDMI network is able to receive and translate from and into CEC, the control device can control even legacy HDMI devices. On the control device, graphical elements could be used to simplify the operation and control of HDMI devices.

In other words, a communicationally connected control device receives information about an HDMI network, particularly about the members of the HDMI network and then provides softkeys (selectable icons) for selection of an HDMI device based on the received information. Further, the control device offers softkeys for selecting respective commands as to control the selected HDMI device. The control device then transmits commands selected by the user to a predetermined network device which in turn generates a CEC command on the basis of the received command. The communication path between the control device and the HDMI device may be one of a wired or wireless IP connection, preferably an Ethernet connection, a Bluetooth connection, a IrDA connection, a GSM/GPRS connection, a 3G (3^{rd} generation of mobile communications technology) 4G (4^{th} generation of mobile communications technology) connection, more generally a radio-frequency based connection, just to mention some of them.

It is to be understood that both the foregoing general description of the invention and the following detailed description are exemplary, but are not restrictive, of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a block diagram of a typical HDMI network scenario and a tablet computer for controlling the HDMI network;

FIG. 2 shows a block diagram of the scenario of FIG. 1 together with an illustrative command;

FIGS. 3a and 3b show two examples of a graphical user interface for selecting and controlling an HDMI device; and

FIGS. 4a and 4b show two tables of information.

### DESCRIPTION OF THE EMBODIMENTS

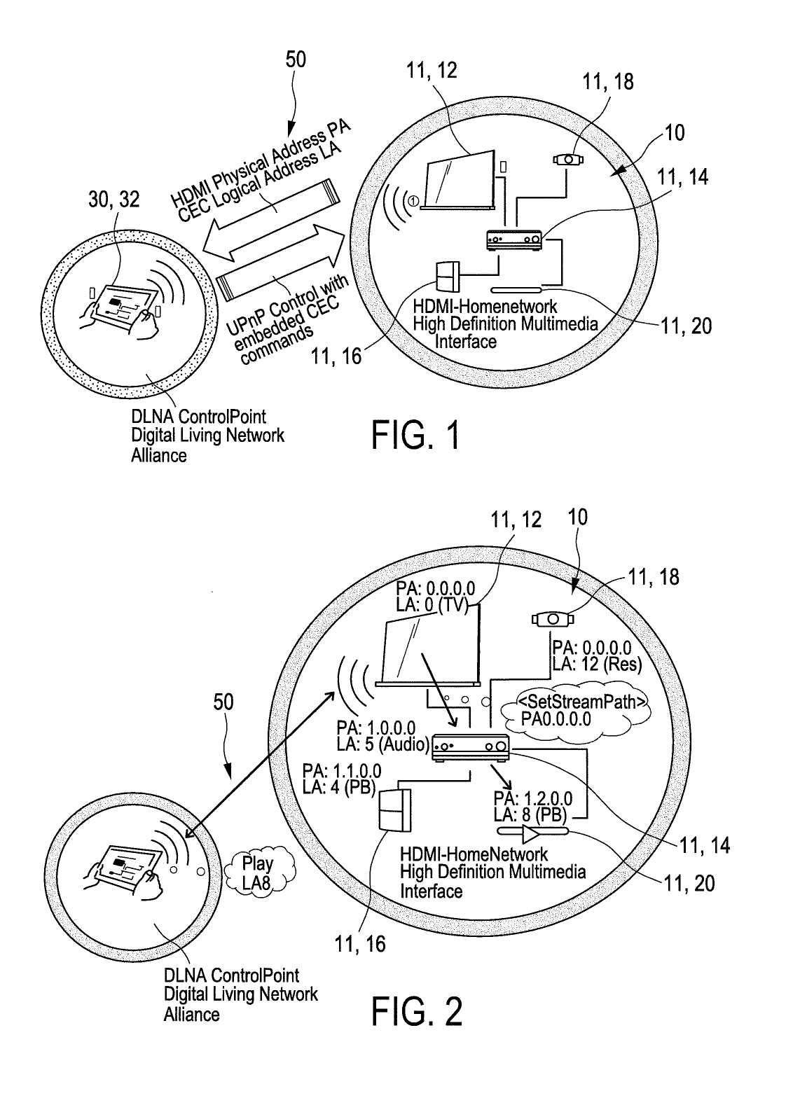

Referring now to the drawings, wherein like reference numerals designate identical or corresponding parts throughout the several views, FIG. 1 shows in an illustrating manner an HDMI network designated by reference numeral 10.

The HDMI network 10 comprises at least two HDMI devices coupled with each other via an HDMI cable. In the present embodiment the HDMI network 10 comprises a TV set 12 which is coupled with an A/V receiver 14. The receiver 14 in turn is coupled with a game console 16, a beamer 18 and playback device 20, for example a Blu-ray disc player. This structure of the HDMI network is chosen just for illustrative purposes. Other structures with different HDMI devices are also possible.

One of the HDMI devices 11, in this example preferably the TV set 12, is equipped with a further data interface, e.g. an IP interface, allowing to communicate, preferably wirelessly, with other devices outside the HDMI network using any kind of data protocol, e.g. IP protocols like TCP/IP. Any other HDMI device could also be equipped with a data interface, like an IP interface.

The data interface of the HDMI device could be a common wired or wireless IP interface (based on e.g. the Ethernet protocol), a bluetooth interface, a IrDA (infrared data association) interface, or GSM, GPRS, 3G, or 4G interface, as to mentioned some of them.

The HDMI devices 11 of the HDMI network 10 are equipped with the HDMI feature CEC (consumer electronics control) which is designed to allow the user to command and control CEC-enabled devices that are connected through HDMI by using only one of their remote controls (for example by controlling the television set 12, the receiver 14 and the Blu-ray disc player 20 using only the remote control of the TV set). CEC also allows for individual CEC-enabled devices to command and control each other without user intervention.

The user is for example allowed to start the Blu-ray disc player 20 via the TV set remote control and the start command also switches on the TV set and the receiver. Further, the appropriate source selection in the receiver 14 is commanded so that a video stream from the Blu-ray disc player is passed through to the TV set 12.

All these commands are transmitted via CEC from the TV set 12 receiving the command from the remote control to the appropriate HDMI devices.

Each HDMI device 11 in the HDMI network 10 is assigned a physical address as well as a logical address. A physical address as well a logical address is unique within the network and carries further information, for example, about the location of the respective device within the network and the type of device. For example, the physical address PA1.1.0.0 shows that the device is in the second “level” and connected with the device with the physical address 1.0.0.0. Further, the logical address is assigned on the basis of the type of device, for example, a TV set has logical address 0 and the playback device 1 has the logical address 4.

In FIG. 2, the respective assigned physical and logical addresses are shown for each HDMI device 11.

Hence, on the basis of the physical addresses and the logical addresses of an HDMI network, the network topology may be drafted.

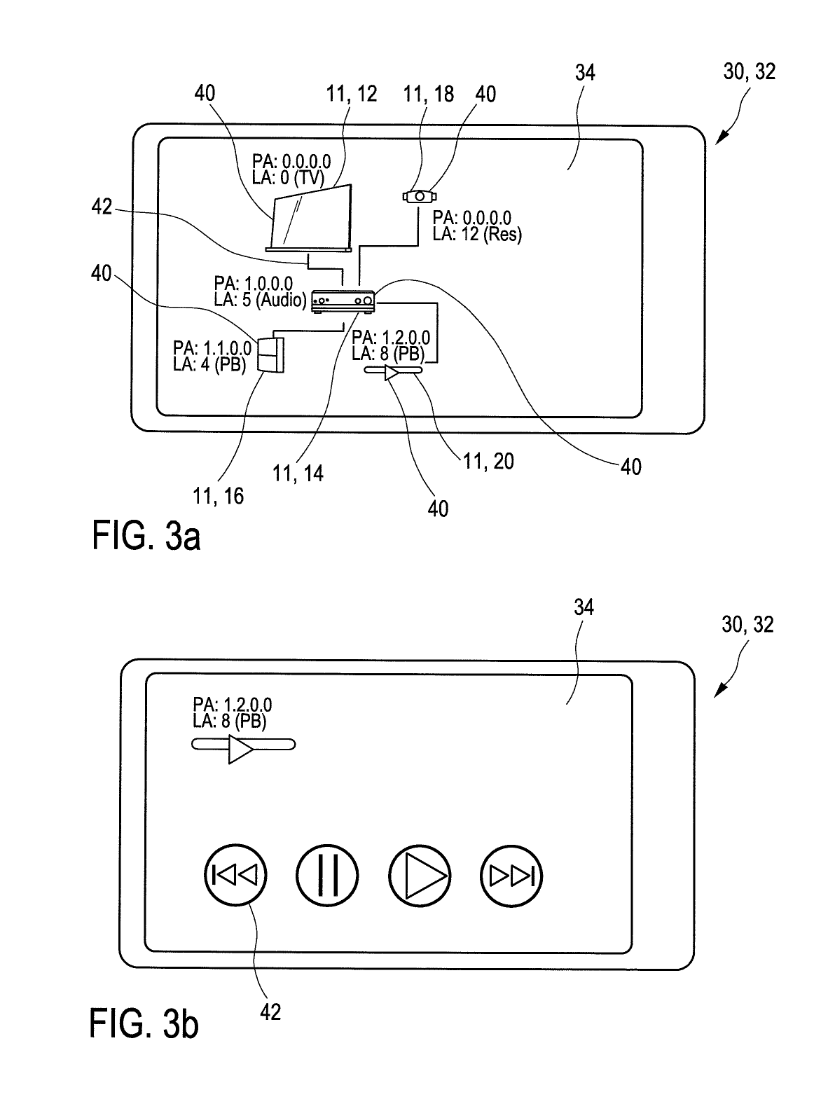

This possibility of drafting an HDMI network on the basis of physical and logical addresses is used by an application running on a mobile device 30, for example, a tablet computer 32. This particular application evaluates the physical and logical address data and displays a picture of the HDMI topology. An example of this is shown in FIG. 3a illustrating a display screen 34 of the mobile device 30. On the display 34, the HDMI devices 11 of the network 10 (as shown in FIG .1) are displayed as icons 40 with lines 42 representing the respective connections between the devices.

The icons 40 shown in the display 34 are selectable icons meaning that the user can for example touch on an icon 40 as to make a selection. The icons represent softkeys.

This graphical user interface allows the user to “transform” the mobile device 30 into a remote control for the selected HDMI device. For example, if the user wants to command the TV set with his mobile device 30, the user touches the icon 40 of the TV set.

Here it is to be noted that the described graphical user interface is based on a touch-sensitive display 34. However, a respective graphical interface could also be implemented for other mobile devices without touch-sensitive displays. For selecting an HDMI device, a scrollable list could for example be used instead of selectable icons.

After the selection of an icon 40 and hence an HDMI device 11, the application running on the mobile device 30 presents a set of command icons 42 (also serving as softkeys) on the display 34. The set of displayed command icons 42 is dependent on the type of HDMI device selected before.

Alternatively, the selection of an icon may power up the selected device instantly, zoom the icon and present control means in graphical way eg. if the amplifier will be zoomed, the volume knob can be used as volume control means, as to list some of the alternatives.

If the user has selected the playback device 20 (Blu-ray disc player), preferably at least four command icons 42 are displayed for the commands rewind, stop, play and forward.

Now, the display 34 displays a graphical user interface of a remote control for the selected HDMI device, namely the Blu-ray disc player. It is without saying that the graphical user interface with the set of four command icons 42 is just an example. Other sets of commands are of course conceivable.

As before, the command icons 42 are selectable and by touching them, the user could select a respective command.

The mobile device 30 hence operates as a “classical” remote control.

However, the mobile device 30 does not communicate with an HDMI device via a typical remote control interface, like IrDA, for example. Instead, in the present embodiment the mobile device 30 communicates with one of the HDMI devices via an IP connection, preferably via a wireless LAN (WLAN) connection. This is advantageous because mobile devices are generally equipped with a WLAN (WiFi) interface.

Nevertheless the data communication between the mobile device 30 and the HDMI device could also be achieved by using a bluetooth connection, an IrDA connection, a GSM,GPRS,3G and/or 4G connection, any other wired/wireless connection or combinations thereof.

In order to allow IP communication, one of the HDMI devices 11 has to be equipped with a respective interface, for example, a WLAN interface.

In the present embodiment shown in FIG. 1, the TV set 12 is provided with WLAN capability so that the communication between the mobile device 30 and the HDMI network 10 is supported by the TV set 12.

Commands selected by the user on the graphical user interface of the mobile device 30 are received by the TV set 12 and are translated into respective CEC commands to be sent to the appropriate HDMI devices within the HDMI network 10. “Translating” means that the TV set already receives embedded CEC commands which are just unpacked and forwarded. However, it also means that the TV set 12 receives commands in another format and generates CEC commands on the basis of the received commands. Further it can also mean that the mobile device offers“new” commands that initiates a set of CEC commands instantly

As already mentioned before, the application running on the mobile device 30 uses physical and logical addresses to build-up the graphical user interface showing the HDMI devices 11 of the network 10. This information is generated and transmitted by the TV set 12 to the mobile device 30. The physical addresses and logical addresses of the HDMI devices may be already available in the TV set or the TV set can poll the CEC line to receive information about connected devices.

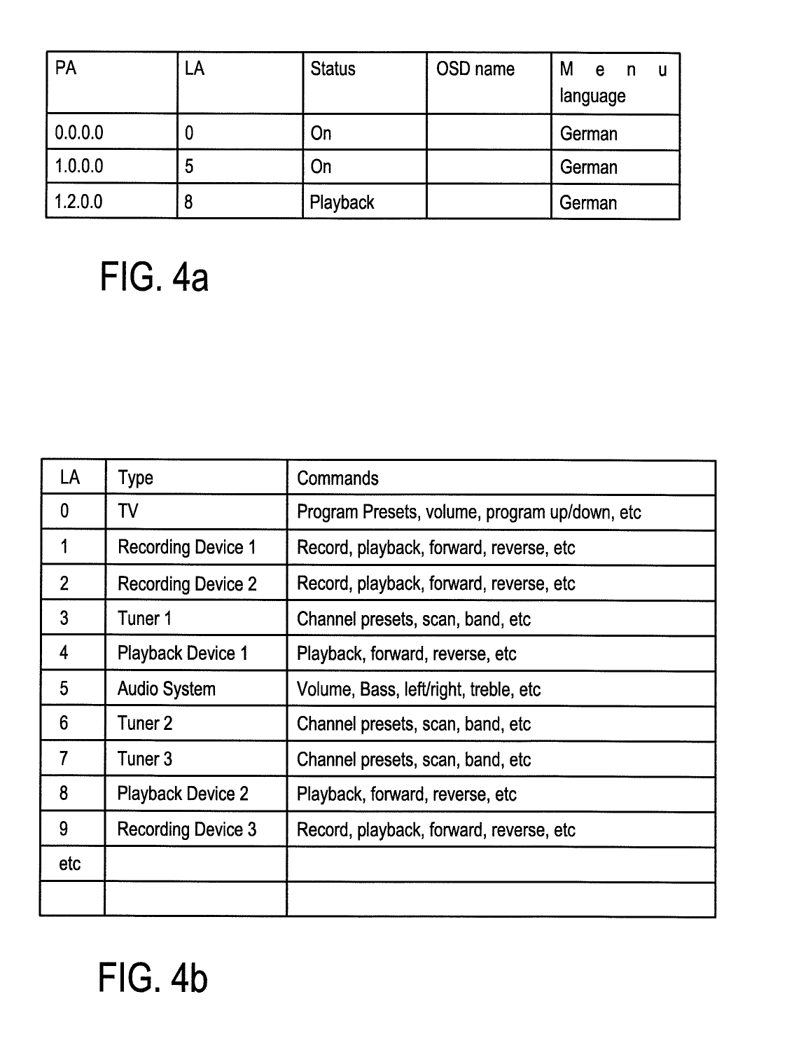

FIG. 4a shows a table of such information transmitted to the mobile device 30. In addition to the physical addresses and the logical addresses, the information sent could also comprise further information for example on the status of HDMI devices, their OSD name or the menu language. Further information could also be added.

On the basis of the received information from the TV set, the application running on the mobile device 30 is able to draft the HDMI network topology, as for example shown in FIG. 3a. The icons representing HDMI devices may also contain status information eg. device is in Standby, thus the icon showing graphically that this device is in standby.

The second graphical user interface, as shown in FIG. 3b, is generated on information stored in the application itself In particular, the application stores for example a table as shown in FIG. 4b signing the set of commands to a type of HDMI device indicated by the logical address. In other words, the application receives the logical address of the selected HDMI device and then uses the set of commands stored in the table and assigned to the respective logical address.

Here, it is to be noted that the sets of commands shown in FIG. 4b are merely illustrative. HDMI devices are able to react on much more commands than provided e.g. by a conventional IR remote control. These additional commands could also be offered in the second graphical user interface.

As already mentioned before, the communication between the mobile device 30 and the TV set 12 operating as an IP-HDMI bridge device is carried out via wireless LAN which is designated by reference numeral 50 in FIGS. 1 and 2. It is without saying that the connection between the mobile device and the TV set could also be made by wire or a combination of wireless and wire. For example, the mobile device communicates wirelessly via an access point which in turn is connected to the TV set by wire.

The TV set 12 transmits HDMI physical address PA and CEC logical address LA to the mobile device 30 and the mobile device 30 transmits back for example in form of an UPnP control with embedded CEC commands to the TV set. The TV set 12 then unpacks the received data and transmits the CEC commands to the respective HDMI devices addressed by the user.

An example is shown in FIG. 2 and will be described below. Assuming that a Blu-ray disc player 20 is connected to the TV set, the application running on the mobile device shows pictures of the TV set and the Blu-ray disc player in form of icons/softkeys as shown in FIG. 3a. The user selects the Blu-ray disc player 20 and then gets control buttons as shown in FIG. 3b, like play stop forward etc.

If the user now touches the play icon of the graphical user interface, the application sends the play command together with the physical and logical address of the Blu-ray disc player 20 to the TV set 12 via WLAN 50. The TV set translates the WLAN play command to the respective CEC protocol and sends this CEC commands to the Blu-ray disc player with the physical address/logical address that was transmitted. The Blu-ray disc player starts playback and per acknowledge of the CEC commands the TV set can forward the acknowledge via wireless WLAN to the mobile device 30. The application running on the mobile device may for example show any kind of feedback, for example a rotating disk, in order to acknowledge the user action. As a result of selecting the play icon, the Blu-ray disc player screens a video to the TV set 12 via the receiver 14.

Although the embodiment is described in connection with a mobile device, like a tablet computer, a smartphone, etc., other devices are also able to run the application. For example, a PC having e.g. a wired IP connection could also be used. Further, multiple mobile devices may be able to log into the network simultaneously and allow to control HDMI devices simultaneously.

As already mentioned before, the communication between the mobile device and the HDMI device is preferably an IP based communication, like Ethernet. However, other communication techniques are also possible, like Bluetooth, IrDA, etc. For example, using IrDA could be advantageous in terms of power consumption. If the mobile device (as well as the HDMI) is equipped with an IrDA interface, the mobile device is able to wake up and power up the HDMI device by sending a respective command although the data communication interface for receiving commands is switched of.

To sum up, the present disclosure allows that control devices, specifically mobile devices, can be enabled to control HDMI devices. In particular, the control devices could control not only one HDMI device of the network but every HDMI device. As long as one device in the HDMI network can receive and translate command data from the control device into CEC commands and vice versa, the control device, namely the mobile device for example, can control even legacy HDMI devices. Applications on the mobile devices can use graphical elements to simplify the operation and control of HDMI devices. Command combinations, like macro commands, that combine various CEC commands can simplify the control even more, for example name change of an HDMI device can be done easily on a touch keyboard on the mobile device and can be transferred by one touch to the bridging device.

Further the graphical representation of the network on the display of the mobile device could offer streampath highlighting. The Audio and Video stream paths may be highlighted (independently) to illustrate the Audio and Video streaming.

Obviously, numerous modifications and variations of the present disclosure are possible in light of the above teachings. It is therefore to be understood that within the scope of the appended claims, the invention may be practiced otherwise than as specifically described herein.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the invention have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present invention. Further, such a software may also be distributed in other forms, such as via the Internet or other wired or wireless telecommunication systems.

Any reference signs in the claims should not be construed as limiting the scope.

1. Method comprising
transmitting information about network devices of an HDMI, high definition multimedia interface, network by an HDMI network device,
receiving this information by a remote control device
presenting said network devices of said HDMI network on a display of said control device as selectable by a user,
presenting a set of control command softkeys on the display in response to a selection of a network device, the set being selected dependent on the type of network device,
generating control command data on the basis of a selected control command softkey,
transmitting said control command data to said HDMI network device, and
providing a CEC command in response to the received control command data.

2. Method of claim 1, wherein presenting said network devices comprises
presenting a softkey for each network device of the HDMI network.

3. Method of claim 2, wherein each softkey is referenced with respective information received.

4. Method of claim 2, wherein said information comprises logical and physical addresses of a network device.

5. Method of claim 4, wherein said information further comprises at least one of network device status, OSD name, menu language, menu status, CEC version, vendor ID, vendor specification information.

6. Method of claim 4, wherein said set of control commands is selected dependent on the logical address which defines the type of the HDMI network device.

7. Method of claim 1, wherein said control command data comprises a CEC command embedded in transmitted data packets.

8. Method of claim 1, wherein communication between said HDMI network device and said remote control device is based on UPnP (Universal Plug and Play).

9. Method of claim 1, wherein said HDMI device is a TV set.

10. Method of claim 1, wherein said remote control device is a tablet device.

11. Method comprising
providing information about network devices of an HDMI network,
transmitting said information to a remote control device,
receiving control command data from said control device, and
providing a CEC command in response to the received control command data.

12. Method of claim 1, wherein said information about network devices is transmitted via at least one of IP network, peer-to-peer data connection, Bluetooth data connection, IrDA data connection, radio-frequency based connection, wireless local network (WLAN) connection, or GSM, GPRS, 3G or 4G data connection.

13. Method of claim 1, wherein said control command data is transmitted to said HDMI device via at least one of IP network, peer-to-peer data connection, Bluetooth data connection, IrDA data connection, radio-frequency based connection, wireless local network (WLAN) connection, or GSM, GPRS, 3G or 4G data connection.

14. Method comprising
obtaining information about network devices of an HDMI network,
providing control command softkeys for control commands assigned to the HDMI network device selected by a user,
transmitting control command data to an HDMI network device in response to a control command selected by the user via one of the softkeys.

15. Control device for remotely controlling network devices of an HDMI network, comprising
a display,
a communication interface adapted to communicate with an HDMI network device,
a network device selection unit adapted to receive a network device selection command by a user,
a control command selection unit adapted to display at least one control command softkey associated with said selected network device on the display, and
a control command data generation unit adapted to generate control command data for transmitting to said HDMI network device in response to the selection of a control command softkey.

16. Control device of claim 15, wherein said control device is a tablet device.

17. Control device of claim 15, wherein said communication interface is adapted to provide a UPnP (universal plug and play) based communication.

18. Control device of claim 15, wherein said communication interface is adapted to provide wireless communication.

19. Control device of claim 15, wherein said display is a touch sensitive display.

20. Control device of claim 15, comprising an evaluation unit adapted to evaluate information about network devices of an HDMI network received from an HDMI device via said communication interface.

21. HDMI device comprising
a communication interface adapted to communicate with a control device,
an HDMI network information generation unit adapted to generate information about the network devices of the HDMI network,
a command receiving unit adapted to receive data from the control device via the communication interface and to provide a CEC command on the basis of the received data.

22. HDMI device, wherein said device is a TV set having an HDMI interface and an further data communication interface.

23. HDMI device of claim 22, wherein said further data communication interface is one of IP network interface, Ethernet interface, peer-to-peer data interface, Bluetooth data interface, IrDA data interface, radio-frequency based data interface, wireless local network (WLAN) data interface, or GSM, GPRS, 3G or 4G data interface.

24. A computer program comprising program code means for causing a device to perform the steps of said method as claimed in claim 1, when said computer program is carried out on a device having a microprocessor.

25. A non-transitory computer-readable recording medium that stores therein a computer program product, which, when executed by a processor, causes the method according to claim 1, to be performed.
